(19) United States
(12) Patent Application Publication
(10) Pub. No.: US 2024/0119600 A1
(43) Pub. Date: Apr. 11, 2024

(54) VIDEO PROCESSING APPARATUS, VIDEO PROCESSING METHOD AND PROGRAM

(71) Applicant: Nippon Telegraph and Telephone Corporation, Tokyo (JP)

(72) Inventors: Hirokazu KAKINUMA, Musashino-shi, Tokyo (JP); Shota YAMADA, Musashino-shi, Tokyo (JP); Hidenobu NAGATA, Musashino-shi, Tokyo (JP); Kota HIDAKA, Musashino-shi, Tokyo (JP)

(21) Appl. No.: 18/271,903

(22) PCT Filed: Jan. 15, 2021
(86) PCT No.: PCT/JP2021/001198

§ 371 Date: Jul. 12, 2023

(51) Int. Cl. G06T 7/194; G06V 10/56

(52) U.S. Cl. CPC G06T 7/194; G06V 10/56; G06T 2207/10024

(57) ABSTRACT

A video processing device includes a foreground region estimation unit that determines whether a pixel of an input image is a foreground or a background, and a blinking correction unit that determines, for a target pixel on which a foreground and a background have been switched, whether switching between the foreground and the background is a color change in the foreground or in the background by using a lookup table capable of determining whether switching is in the foreground or in the background from a temporal change of a pixel value, and corrects a result of determination as to whether it is the foreground or the background that has been performed for the target pixel in a case where the switching between the foreground and the background is the color change in the foreground or in the background.

### TECHNICAL FIELD

The present invention relates to a video processing device, a video processing method, and a video processing program.

### BACKGROUND ART

A technique for extracting a subject from a video is known (see Patent Literature 1). The subject is extracted by classifying each pixel of an input video into a foreground or a background and giving a foreground label or a background label, and extracting only pixels to which the foreground label is given. At this time, the video processing device executes processing of comparing each pixel value of the input video with a predetermined color model and calculating a probability or a score of being the foreground or the background, comparing the magnitude of the probability or the score with a predetermined threshold, and giving the foreground label or the background label to all pixels on the basis of a result of the comparison.

### CITATION LIST

### Patent Literature

Patent Literature 1: JP 6715289 B2

### SUMMARY OF INVENTION

### Technical Problem

The input video is an aggregate of a series of still images (hereinafter, input images) continuously input, and the comparison processing is executed for each input image. Thus, depending on the pixel value and the threshold used at the time of label assignment, there is a case where the label type of the input image changes at each time, such as a case where a pixel to which the foreground label is given in the input image at a predetermined time is given the background label in the input image at the next time. At this time, an image obtained by extracting only the pixels to which the foreground label is given is a subject extraction image, but when a viewer observes a subject extraction video obtained by connecting a plurality of subject extraction images, there is a problem that a change in label type with respect to the pixel (switching between the foreground and the background in the subject) appears as flickering, and subjective quality is deteriorated.

The present invention has been made in view of the above circumstances, and an object of the present invention is to provide a technology capable of improving flickering of a video.

### Solution to Problem

A video processing device according to one aspect of the present invention includes a determination unit that determines whether a pixel of an input image is a foreground or a background, and a correction unit that determines, for a target pixel on which a foreground and a background have been switched, whether switching between the foreground and the background is a color change in the foreground or in the background by using a lookup table capable of determining whether switching is in the foreground or in the background from a temporal change of a pixel value, and corrects a result of determination as to whether it is the foreground or the background that has been performed for the target pixel in a case where the switching between the foreground and the background is the color change in the foreground or in the background.

A video processing method according to one aspect of the present invention includes determining whether a pixel of an input image is a foreground or a background, and determining, for a target pixel on which a foreground and a background have been switched, whether switching between the foreground and the background is a color change in the foreground or in the background by using a lookup table capable of determining whether switching is in the foreground or in the background from a temporal change of a pixel value, and correcting a result of determination as to whether it is the foreground or the background that has been performed for the target pixel in a case where the switching between the foreground and the background is the color change in the foreground or in the background.

One aspect of the present invention is a video processing program for causing a computer to function as the video processing device.

### Advantageous Effects of Invention

According to the present invention, it is possible to provide a technology capable of suppressing flickering of a video.

### BRIEF DESCRIPTION OF DRAWINGS

FIG. 1 is a block diagram illustrating a basic configuration of a video processing device.

FIG. 2 is a flowchart illustrating a basic operation of the video processing device.

FIG. 3 is a block diagram illustrating a specific configuration of the video processing device.

FIG. 4 is an image diagram illustrating learning processing of an estimation NN.

FIG. 5 is an image diagram illustrating learning processing of a correction NN.

FIG. 6 is a flowchart illustrating an operation example of the video processing device.

FIG. 7 is a flowchart illustrating an operation example of the video processing device.

FIG. 8 is a block diagram illustrating a hardware configuration of the video processing device.

### DESCRIPTION OF EMBODIMENTS

Hereinafter, an embodiment of the present invention is described with reference to the drawings. In the drawings, the same portions are denoted by the same reference signs, and description thereof is omitted.

### SUMMARY OF INVENTION

The present invention determines, for a pixel on which flickering appears due to a temporal change, whether the flickering appears in the same region (in a foreground or in a background), and corrects a given label type in a case where the flickering appears in the same region. Specifically, in addition to referring to a lookup table (LUT) for determining whether it is the foreground or the background described in Patent Literature 1, the above is achieved by referring to the LUT for determining whether it is flickering in the foreground or in the background from the temporal change of a pixel value. However, the LUT of Patent Literature 1 is merely one means for determining whether the object is the foreground or the background, and in the present invention, any foreground/background determination means such as an existing background difference method can be used.

### [Basic Configuration of Video Processing Device]

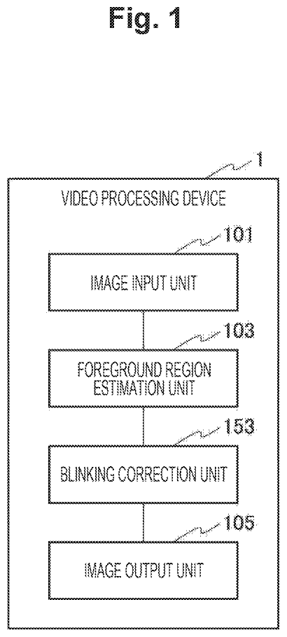

FIG. 1 is a block diagram illustrating a basic configuration of a video processing device 1 according to the present embodiment. The video processing device 1 includes an image input unit 101, a foreground region estimation unit 103, a blinking correction unit 153, and an image output unit 105. The image input unit 101, the foreground region estimation unit 103, and the image output unit 105 have functions similar to those described in Patent Literature 1.

The image input unit 101 has a function of acquiring, from an input video input to video processing device 1, a still image constituting the input video as an input image. The image input unit 101 has a function of acquiring a background image for a background created in advance by a user.

The foreground region estimation unit (determination unit) 103 has a function of referring to the LUT of Patent Literature 1 (hereinafter, the estimation LUT) capable of determining whether it is a foreground or a background for a combination of respective pixels paired at the same coordinates of the input image and the background image, and determining whether a pixel of an input image is the foreground or the background.

The blinking correction unit (correction unit) 153 has a function of referring to an LUT (hereinafter, a correction LUT) capable of determining whether it is flickering (switching of the foreground and the background in the same region) in the foreground or in the background from a temporal change of a pixel value with respect to a combination of respective pixels paired at the same coordinates of an input image of one frame before and an input image of a current frame only for a target pixel on which the foreground and the background are switched, determining whether the switching between the foreground and the background is a color change in the foreground or in the background or a color change in which the foreground and the background are switched, and correcting a result of determination as to whether it is the foreground or the background that has been performed for the target pixel in a case where the switching is the color change in the foreground or in the background.

The image output unit 105 has a function of outputting, to a display, a video obtained by connecting a plurality of subject extraction images as a subject extraction video, with only pixels determined to be the foreground as the subject extraction image.

### [Basic Operation of Video Processing Device]

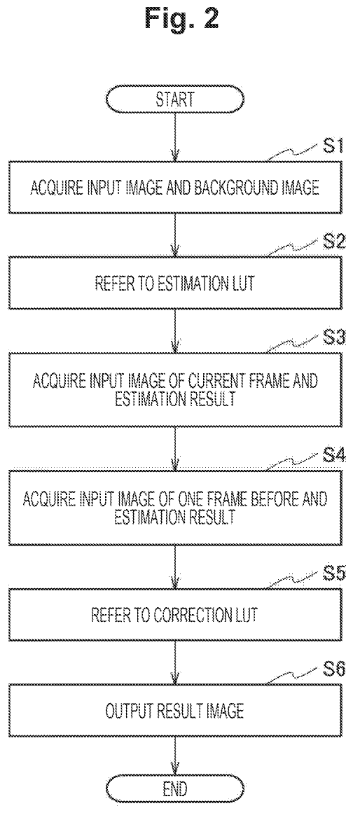

FIG. 2 is a flowchart illustrating a basic operation of the video processing device 1.

Step S1;

First, the image input unit 101 acquires an input image from an input video input to the video processing device 1, and acquires a separately created background image.

Step S2;

Next, the foreground region estimation unit 103 refers to the estimation LUT for a combination of respective pixels paired at the same coordinates of the input image and the background image, determines whether each pixel of the input image is the foreground or the background from the estimation LUT, and gives the foreground label or the background label to each pixel on the basis of a result of the determination.

Step S3;

Next, the blinking correction unit 153 acquires the input image of a current frame, and acquires a label type given to each pixel of the input image of the current frame. That is, the blinking correction unit 153 acquires the input image acquired by the image input unit 101 in step S1, and acquires the label type given by the foreground region estimation unit 103 in step S2.

Step S4;

Next, the blinking correction unit 153 acquires the input image of one frame before, and acquires the label type given to each pixel of the input image of the one frame before.

Step S5;

Next, the blinking correction unit 153 determines whether the label type has been switched in respective pixels paired at the same coordinates of the input image of the one frame before and the input image of the current frame. Then, the blinking correction unit 153 refers to the correction LUT for the combination of respective pixels paired at the same coordinates of the input image of the one frame before and the input image of the current frame only for the pixel on which the foreground label and the background label have been switched, determines whether the switching between the foreground label and the background label is a color change in the same type of label from the estimation LUT, and changes the label type given in step S2 in a case where the switching is a color change in the same type of label. For example, in a case where the foreground label has been switched to the background label, the blinking correction unit 153 changes the background label to the foreground label.

Step S6;

Finally, the image output unit 105 outputs only the pixel determined as the foreground to the display as the subject extraction image.

### Specific Example of Video Processing Device

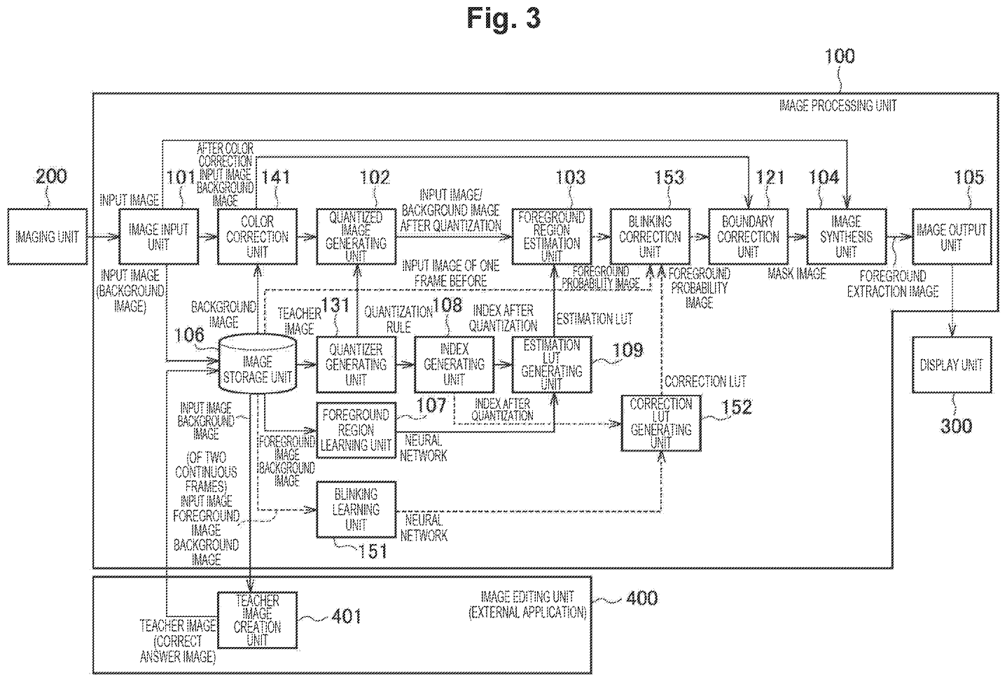

FIG. 3 is a block diagram illustrating a configuration example in which the basic configuration of the video processing device 1 illustrated in FIG. 1 is applied to the video processing device of Patent Literature 1. The video processing device 1 includes an image processing unit 100, an imaging unit 200, a display unit 300, and an image editing unit 400.

The image processing unit 100 includes the image input unit 101, a color correction unit 141, a quantized image generating unit 102, the foreground region estimation unit 103, a boundary correction unit 121, an image synthesis unit 104, the image output unit 105, an image storage unit 106, a quantizer generating unit 131, a foreground region learning unit 107, an index generating unit 108, an estimation LUT generating unit 109, a blinking learning unit 151, a correction LUT generating unit 152, and the blinking correction unit 153.

The image processing unit 100 according to the present embodiment adds the blinking learning unit 151 and the correction LUT generating unit 152 to the video processing device of Patent Literature 1, and adds the blinking correction unit 153 that refers to the correction LUT of the correction LUT generating unit 152 between the foreground region estimation unit 103 and the boundary correction unit 121.

Hereinafter, the added functional units and functional units highly related to the present invention will be described. Other respective functional units, the imaging unit 200, the display unit 300, and the image editing unit 400 have functions similar to those described in Patent Literature 1. Note that the foreground region learning unit 107 is the learning unit 107 of Patent Literature 1. The estimation LUT generating unit 109 is the LUT generating unit 109 of Patent Literature 1.

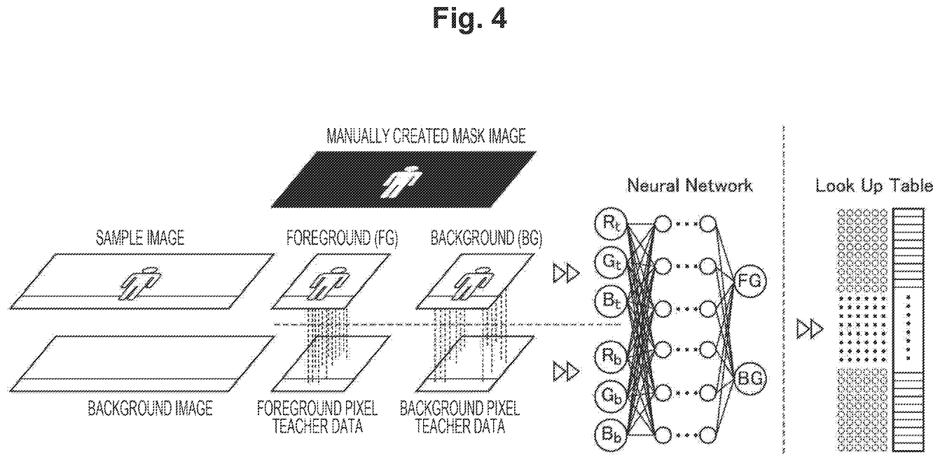

As illustrated in FIG. 4, the foreground region learning unit 107 has a function of constructing a neural network (hereinafter, estimation NN) that outputs a probability (FG: Foreground) that a combination of a pixel value (Rₜ, Gₜ, Bₜ) of a sample image and a pixel value (R_{b}, G_{b}, B_{b}) of the background image is the foreground and a probability (BG: Background) that the combination is the background on the basis of the sample image, a manually created mask image of only the foreground, and the background image. The foreground region learning unit 107 has a function of inputting a plurality of sample images to the estimation NN to cause the estimation NN to repeatedly learn. The estimation NN has a function of determining whether the pixel of the input image is the foreground or the background with respect to the background image when the input image is input instead of the sample image at the time of inference. Details of the learning method of the estimation NN are as described in Patent Literature 1.

The estimation LUT generating unit 109 has a function of generating an estimation LUT in which an input/output relationship of the estimation NN is tabulated. Specifically, the estimation LUT generating unit 109 inputs all combinations of six-dimensional pixel values to the estimation NN, and obtains outputs associated with them, thereby tabulating the relationship between input and output. Note that the reason for the tabulation is that arithmetic processing of the NN generally takes time and is not suitable for real-time processing on a moving image.

The foreground region estimation unit 103 has a function of inputting the input image and the background image subjected to the color correction by the color correction unit 141 and quantized by the quantized image generating unit 102 (the number of gradations of the pixel value is reduced), referring to the estimation LUT generated by the estimation LUT generating unit 109 for the combination of respective pixels paired at the same coordinates of the input image and the background image, and determining whether a pixel of the input image is the foreground or the background.

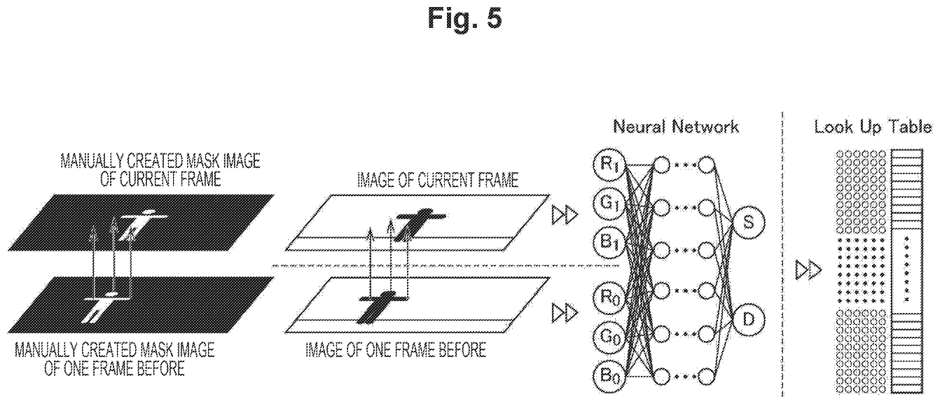

As illustrated in FIG. 5, the blinking learning unit 151 has a function of constructing a neural network (hereinafter, a correction NN) that outputs a probability (S: Same) that a combination of a pixel value (R₀, G₀, B₀) of the input image of the one frame before and a pixel value (R₁, G₁, B₁) of the input image of the current frame paired at the same coordinates is in the same foreground or the same background, and a probability (D: Different) that the combination is not in the same foreground or the same background, on the basis of an image of the one frame before, an image of the current frame, a mask image obtained by masking the background from the image of the one frame before, and a mask image obtained by masking the background from the image of the current frame. The blinking learning unit 151 has a function of inputting a plurality of input images one frame before and input images of a plurality of current frames to the correction NN to cause the correction NN to repeatedly learn. Details of a learning method of the correction NN will be described later.

The correction LUT generating unit 152 has a function of generating the correction LUT in which an input/output relationship of the correction NN is tabulated. Specifically, for combinations of all colors, the correction LUT generating unit 152 inputs all combinations of the six-dimensional pixel values to the correction LUT and obtains outputs associated with them, thereby tabulating the relationship between input and output. Note that the reason for the tabulation is that the arithmetic processing of the NN generally takes time as described above.

The blinking correction unit 153 has a function of referring to the correction LUT generated by the correction LUT generating unit 152 for a combination of respective pixels paired at the same coordinates of the input image of the one frame before and the input image of the current frame only for a pixel on which the foreground and the background have been switched as a result of determining whether the pixel of the input image is the foreground or the background in the foreground region estimation unit 103, determining whether the switching between the foreground and the background is a color change in the foreground or in the background, and correcting a result of determination of the foreground region estimation unit 103 in a case where the switching is the color change in the foreground or in the background.

### [Learning Method of Correction NN]

The blinking learning unit 151 repeatedly executes the following processing for all pixels included in an image. Since it takes time to perform arithmetic processing when the arithmetic processing is executed for all the pixels, the arithmetic processing may be executed for a predetermined number of randomly sampled pixels.

First, the blinking learning unit 151 acquires an image of one frame before and an image of the current frame.

Next, the blinking learning unit 151 creates a mask image (white: subject to be the foreground, and black: background) in which a subject region is manually cut out from the image of the one frame before. Similarly, the blinking learning unit 151 creates a mask image (white: subject to be the foreground, and black: background) in which the subject region is manually cut out from the image of the current frame.

Finally, the blinking learning unit 151 learns, by the correction NN, teacher data in which whether a color change is in the same foreground or in the same background is defined with respect to a combination of a pixel value of the image of the one frame before and a pixel value of the image of the current frame paired at the same coordinates.

For example, it is assumed that a predetermined pixel in an image is referred to, the pixel value (R₀, G₀, B₀) of the one frame before is red (255, 0, 0), and the pixel value (R₁, G₁, B₁) of the current frame is orange (255,128, 0). In addition, it is assumed that a pixel having the same coordinates as the predetermined pixel is referred to in the two types of mask images, the label type of the one frame before is the foreground (FG=1, BG=0), and the label of the current frame is the background (FG=0, BG=1). In this case, in the predetermined pixel, since the label type changes between two temporally preceding and following frames, it can be determined that the color change of the predetermined pixel of the one frame before and the current frame is not the color change in the same foreground or the same background. Therefore, in this case, each value of the input and output is determined as (R₀, G₀, B₀, R₁, G₁, B₁, S, D)=(255, 0, 0, 255, 128, 0, 0, 1). The blinking learning unit 151 causes the correction NN to learn the result group determined in this manner as teacher data.

### Operation Example of Video Processing Device

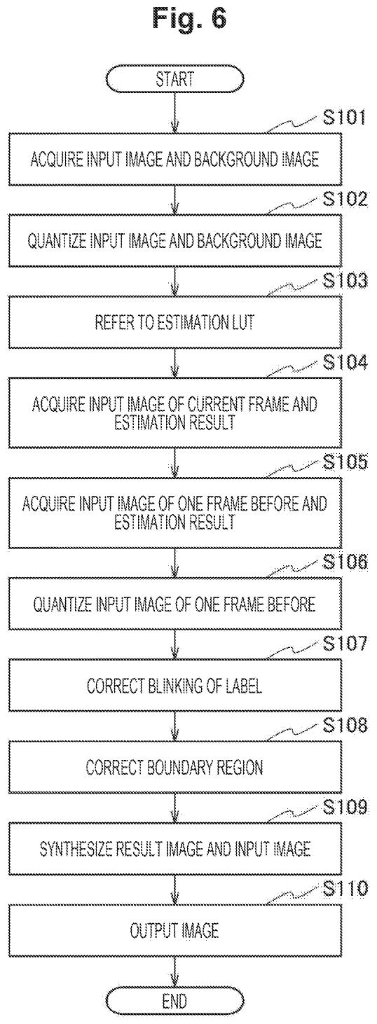

FIG. 6 is a flowchart illustrating an operation example of the video processing device 1 illustrated in FIG. 3.

Step S101;

First, the image input unit 101 acquires an input image from an input video input to the video processing device 1, and acquires a separately created background image.

Step S102;

Next, the quantized image generating unit 102 quantizes the input image and the background image.

Step S103;

Next, the foreground region estimation unit 103 refers to the estimation LUT for a combination of respective pixels paired at the same coordinates of the quantized input image and the quantized background image, determines whether each pixel of the input image is the foreground or the background from the estimation LUT, and gives the foreground label or the background label to each pixel on the basis of a result of the determination.

Step S104;

Next, the blinking correction unit 153 acquires the quantized input image of the current frame, and acquires the label type given to each pixel of the input image of the current frame.

Step S105;

Next, the blinking correction unit 153 acquires the input image of one frame before, and acquires the label type given to each pixel of the input image of the one frame before.

Step S106;

Next, the blinking correction unit 153 quantizes the input image of the one frame before.

Step S107;

Next, the blinking correction unit 153 determines whether the switching between the foreground and the background is a color change in the foreground or in the background only for the pixel on which the foreground and the background are switched, and changes the label type given in step S103 in a case where the switching is the color change in the foreground or in the background. Details of step S107 will be described later.

Step S108;

Next, the boundary correction unit 121 performs correction to clarify a boundary of the foreground with respect to the background, and generates a mask image obtained by extracting only the pixel to which the foreground label is given.

Step S109;

Next, the image synthesis unit 104 synthesizes the mask image with the input image, and generates a foreground extraction image obtained by extracting only the foreground.

Step S110;

Finally, the image output unit 105 outputs the foreground extraction image to the display unit 300.

### [Details of Step S107]

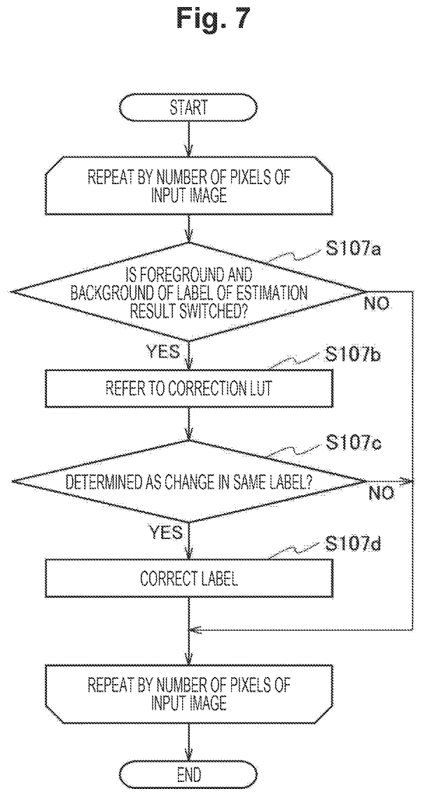

FIG. 7 is a flowchart illustrating a detailed operation of step S107 illustrated in FIG. 6.

Step S107a;

First, the blinking correction unit 153 determines whether the label type has been switched in respective pixels paired at the same coordinates of the input image of the one frame before and the input image of the current frame. In a case where the label type has been switched, the process proceeds to the subsequent step S107b, and in a case where the label type has not been switched, the process proceeds to the above-described step S108.

Step S107b;

Next, the blinking correction unit 153 refers to the correction LUT for a combination of respective pixels paired at the same coordinates of the input image of the one frame before and the input image of the current frame.

Step S107c;

Next, the blinking correction unit 153 determines whether the switching of the label type is a color change in the same type of label from the estimation LUT. In a case where the color change is in the same type of label, the process proceeds to the subsequent step S107d, and in a case where the color change is not in the same type of label, the process proceeds to the above-described step S108.

Step S107d;

Finally, the blinking correction unit 153 changes the label type given in step S103.

[Effects]

According to the present embodiment, the video processing device 1 includes the foreground region estimation unit 103 that determines whether a pixel of an input image is a foreground or a background by using the estimation LUT capable of determining the foreground or the background, and the blinking correction unit 153 that determines, for a target pixel on which the foreground and the background have been switched, whether switching between the foreground and the background is a color change in the foreground or in the background by using the correction LUT capable of determining whether switching is in the foreground or in the background from a temporal change of the pixel value, and corrects a result of determination as to whether it is the foreground or the background performed for the target pixel in a case where the switching between the foreground and the background is the color change in the foreground or in the background. Therefore, it is possible to provide a technology that can suppress flickering of the video.

[Others]

The present invention is not limited to the aforementioned embodiments. The present invention can be modified in various manners within the gist of the present invention.

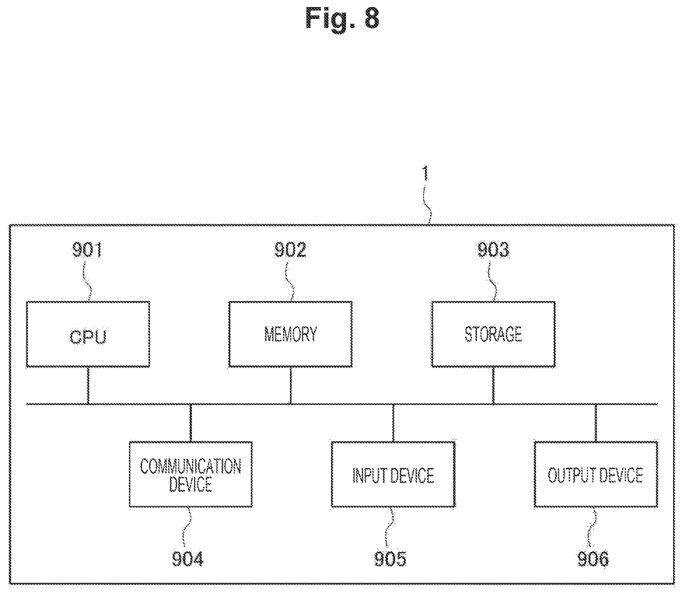

The video processing device 1 of the present embodiment described above can be achieved by using, for example, a general-purpose computer system including a CPU 901, a memory 902, a storage 903, a communication device 904, an input device 905, and an output device 906 as illustrated in FIG. 8. The memory 902 and the storage 903 are storage devices. In the computer system, each function of the video processing device 1 is implemented by the CPU 901 executing a predetermined program loaded on the memory 902.

The video processing device 1 may be implemented by one computer. The video processing device 1 may be implemented by a plurality of computers. The video processing device 1 may be a virtual machine mounted on a computer. The program for the video processing device 1 can be stored in a computer-readable recording medium such as an HDD, an SSD, a USB memory, a CD, or a DVD. The program for the video processing device 1 can also be distributed via a communication network.

### REFERENCE SIGNS LIST

1 Video processing device
100 Image processing unit
101 Image input unit
102 Quantized image generating unit
103 Foreground region estimation unit
104 Image synthesis unit
105 Image output unit
106 Image storage unit
107 Foreground region learning unit
108 Index generating unit
109 Estimation LUT generating unit
121 Boundary correction unit
131 Quantizer generating unit
141 Color correction unit
151 Blinking learning unit
152 Correction LUT generating unit
153 Blinking correction unit
200 Imaging unit
300 Display unit
400 Image editing unit
901 CPU
902 Memory
903 Storage
904 Communication device
905 Input device
906 Output device

1. A video processing device comprising:
a processor; and
a memory device storing instructions that, when executed by the processor, configure the processor to:
determine whether a pixel of an input image is a foreground or a background; and
determine for a target pixel on which a foreground and a background have been switched, whether switching between the foreground and the background is a color change in the foreground or in the background by using a lookup table capable of determining whether switching is in the foreground or in the background from a temporal change of a pixel value, and correct a result of determination as to whether it is the foreground or the background that has been performed for the target pixel in a case where the switching between the foreground and the background is the color change in the foreground or in the background.

2. A video processing method performed by a video processing device, comprising:
determining whether a pixel of an input image is a foreground or a background; and
determining, for a target pixel on which a foreground and a background have been switched, whether switching between the foreground and the background is a color change in the foreground or in the background by using a lookup table capable of determining whether switching is in the foreground or in the background from a temporal change of a pixel value, and correcting a result of determination as to whether it is the foreground or the background that has been performed for the target pixel in a case where the switching between the foreground and the background is the color change in the foreground or in the background.

3. A non-transitory computer readable medium storing a program, wherein executing of the program causes a computer to function as the video processing device according to claim 1.
